(19) United States
(12) Patent Application Publication
(10) Pub. No.: US 2025/0030173 A1
(43) Pub. Date: Jan. 23, 2025

(54) A PROTECTIVE STRUCTURE

(71) Applicant: TUSAS- TURK HAVACILIK VE UZAY SANAYII ANONIM SIRKETI, Kahramankazan/Ankara (TR)

(72) Inventors: Nursev ERDOGAN, Kahramankazan/Ankara (TR); Nail Bugra KILIC, Kahramankazan/Ankara (TR); Anil KUBAN, Kahramankazan/Ankara (TR); Aziz Taner ASTARLIOGLU, Kahramankazan/Ankara (TR)

(21) Appl. No.: 18/711,078

(22) PCT Filed: Oct. 26, 2022
(86) PCT No.: PCT/TR2022/051183

§ 371 Date: May 16, 2024

(30) Foreign Application Priority Data
Nov. 24, 2021 (TR) 2021/018347

(51) Int. Cl. H01Q 17/00; B64C 1/00; B64C 1/06

(52) U.S. Cl. CPC H01Q 17/008; B64C 1/068; B64C 2001/0054

(57) ABSTRACT

At least one protective layer made of vanadium oxide is located on a body of an air and/or space vehicle. The protective layer has conductive or insulating properties at a temperature predetermined by the user.

The present invention relates to a protective structure created to prevent electromagnetic waves, which are emitted for locating and attacking an air vehicle, from reaching the air vehicle surface.

Attacks with radar locating waves or lightning strikes require the air vehicle to ensure security and take precautions. Electromagnetic waves arriving at the air vehicle surface are in the form of a periodically recurring structure, and are fully or partially transmitted or reflected back, depending on the design of the material. Another important security factor is the identification of threats by the air vehicle and the collection of data about targeting and signal intelligence. Electronic warfare is to detect and block emitted signals using electromagnetic energy in order to follow operational planning. Built-in or external protection systems are provided on the air vehicle for the protection of emitted waves in case of an electronic warfare.

The United States patent document U.S. Pat. No. 10,444,417, which is included in the known-state of the art, discloses an optical limiter used to prevent electromagnetic waves that may damage sensors and equipment in the air vehicle. This document explains that waves with a certain frequency value can be reflected back using an optical limiter. It also discloses that a photocathode a material configured to be triggered for a phase transition, and power units are used, and that a tungsten is provided in the structure of the material triggered for phase transition. It discloses the use of metal for the transmission of electrons transmitted from the power unit and the creation of apertures in the architecture inside the device to strengthen the electric field formed.

Thanks to a protective structure according to the present invention, radar visibility of the air vehicle is reduced and electronic warfare waves are reflected back through a single structure.

Thanks to a protective structure according to the present invention, a multi-functional coating is applied on the air vehicle, and the air vehicle is protected against electronic warfare.

The protective structure realized to achieve the object of the invention, which is defined in the first claim and other claims dependent thereon, comprises at least one body constituting an air vehicle that is a manned and/or unmanned aircraft; at least one protective layer located on the body, which is conductive against electromagnetic waves that can be directed to the air vehicle at temperatures lower than phase transformation temperature, and which is insulating against electromagnetic waves that can be directed to the air vehicle at temperatures higher than the phase change temperature. The protective layer is made of vanadium dioxide (VO2).

The protective structure according to the invention comprises at least one magnetic layer which is coated on the protective layer with an impedance value predetermined by the user, wherein if warfare waves directed to damage the air vehicle equals to the impedance value predetermined by the user, the magnetic layer absorbs the warfare waves almost completely on itself and is heated by high resonance frequency and magnetic resonance created, so that it allows temperature of the protective layer to increase as a result of its heating and transforms the protective layer into a conductive phase by exceeding the phase change temperature.

In an embodiment of the invention, the protective structure, creates a low resonance frequency due to radar waves directed for locating the air and/or space vehicle are at least partially absorbed on the magnetic layer. Accordingly, the magnetic layer cannot heat the protective layer enough to provide the phase change temperature predetermined by the user, and the protective layer keeps its insulating form such that it is transparent for incoming waves. Radar waves passing through the protective layer are absorbed by at least one radar absorbing layer (RAM) positioned between the protective layer and the body.

In an embodiment of the invention, the protective structure comprises the magnetic layer which has a surface resistance predetermined by the user to be higher than a surface resistance of the protective layer, thus increasing the capacity to absorb the electromagnetic waves thereon.

In an embodiment of the invention, the protective structure comprises the magnetic layer which is heated as a result of the resonance frequency formed by absorbing the electromagnetic waves transmitted thereon, and which allows the protective layer to be triggered directly without a need for any other power source, so that the protective layer reaches the phase transformation temperature and is transformed into a conductive phase with metallic properties.

In an embodiment of the invention, the protective structure comprises the protective layer which is located on the body forming an outer surface of the air vehicle, so as to surround an area where the electronic equipment in the air vehicle are located.

In an embodiment of the invention, the protective structure comprises the magnetic layer located on the protective layer and for which impedance value can be changed according to a thickness predetermined by the user.

In an embodiment of the invention, the protective structure comprises the protective layer doped with silicon (Si), thus reducing the transition temperature from the monoclinic phase, which has insulating properties, to the rutile phase, which has conductive properties.

In an embodiment of the invention, the protective structure comprises a radar absorbing layer, which is coated on the body using a spraying method.

In an embodiment of the invention, the protective structure comprises the protective layer, which is coated on the radar absorbing layer using the spraying method.

In an embodiment of the invention, the protective structure comprises the magnetic layer, which is coated on the protective layer using the spraying method.

In an embodiment of the invention, the protective structure comprises at least one polymer layer applied on the magnetic layer using a spray coating method, which substantially protects the magnetic layer against factors such as humidity and/or friction to which it may be exposed.

In an embodiment of the invention, the protective structure comprises the magnetic layer in hexa ferrite structure made of barium ferrite (BaFe₁₂O₁₉), manganese ferrite (MnFe₂O₄), cobalt ferrite (CoFe₂O₄), nickel ferrite (NiFe₂O₄), copper ferrite (CuFe₂O₄) or zinc ferrite (ZnFe₂O₄).

In an embodiment of the invention, the protective structure comprises the radar absorbing layer made of indium tin oxide (InSnO₂) or zinc tin oxide (ZnSnO₃).

In an embodiment of the invention, the protective structure comprises the body to which warfare waves in a range of intensity or wavelength predetermined by the user are directed.

In an embodiment of the invention, the protective structure comprises the body to which radar waves in a range of intensity or wavelength predetermined by the user are directed.

The protective layer realized to achieve the object of the present invention is illustrated in the attached drawings, in which:

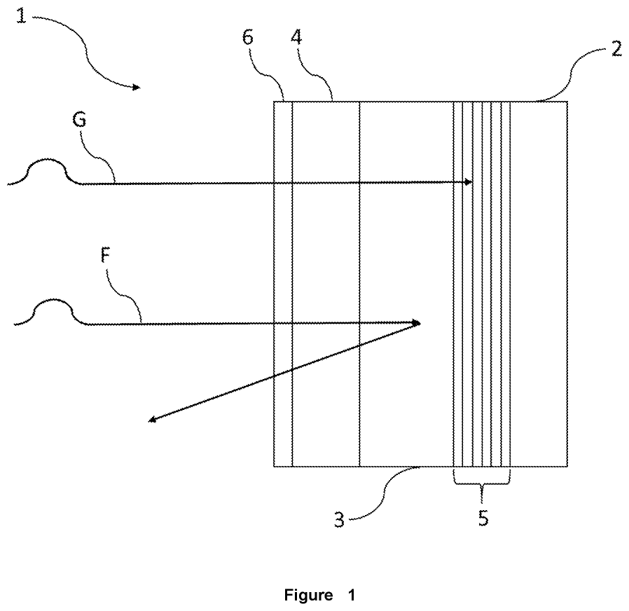

FIG. 1 is a schematic view of the protective structure.

All the parts illustrated in FIGURES are individually assigned a reference numeral and the corresponding terms of these numbers are listed below:
1. Protective Structure
2. Body
3. Protective Layer
4. Magnetic Layer
5. Radar Absorbing Layer
6. Polymer Layer
(F) Warfare Waves
(G) Radar Waves

The protective structure (1) comprises a body (2) which is an air and/or space vehicle; at least one protective layer (3) made of vanadium oxide (VO2), which is located on the body (2) and has conductive or insulating properties at a temperature predetermined by the user.

The protective structure (1) according to the invention comprises at least one magnetic layer (4) which is coated on the protective layer (3) with an impedance value predetermined by the user, wherein if warfare waves (F) directed to the body (2) for an attack is almost equal, the magnetic layer (4) substantially absorbs the warfare waves (F) and is heated by high resonance frequency, thus increasing a temperature of the protective layer (3) and rendering it a conductive structure, so that the warfare waves (F) are reflected back from the protective layer (3) (FIG. 1).

There is provided the protective layer (3) located on the body (2) that is an outer surface of the air and/or space vehicle, wherein the protective layer (3) acts as an insulator or conductor at a temperature below the phase change temperature, allowing the directed electromagnetic waves to pass through to reach the body (2), wherein the protective layer (3) exhibits conductive behavior at a temperature above the phase change temperature, allowing directed electromagnetic waves to be reflected back.

The magnetic layer (4), for which the impedance value is predetermined by the user, is coated on the protective layer (3). In case the warfare waves (F) directed to the body (2) for an electronic attack have almost equal impedance with the magnetic layer (4), the directed warfare waves (F) are substantially absorbed on the magnetic layer (4). As a result of absorbing the warfare waves (F) substantially, the magnetic layer (4) heats up as a result of the resonance frequency and magnetic resonance formed on the magnetic layer (4), and causes the temperature of the protective layer (3) to increase. When the phase transformation temperature of the protective layer (3) predetermined by the user is exceeded, it is transformed into a conductive phase, so that warfare waves (F) from the magnetic layer (4) are reflected back before they reach the body (2). Thanks to the protective layer (3) transformed into the conductive phase, electromagnetic warfare waves (F) directed to the air vehicle can be reflected back before they reach the body.

In an embodiment of the invention, the protective structure (1) comprises at least one radar absorbing layer (5) located between the body (2) and the protective layer (3), wherein when the radar waves (G), which are directed at the air and/or space vehicle with an impedance value lower than the impedance of the magnetic layer (4) predetermined by the user, are at least partially absorbed on the magnetic layer (4) and create the low resonance frequency, the radar absorbing layer (5) allows the protective layer (3) to act as an insulator by remaining under the temperature predetermined by the user, and allows the radar waves (G) passing through the protective layer (3) to be substantially absorbed. Radar waves (G) sent to the air and/or space vehicle for locating, and for which the impedance value is lower than the impedance value of the magnetic layer (4) predetermined by the user, are at least partially absorbed on the magnetic layer (4). However, since the low resonance frequency occurs as a result of this, the protective layer (3) cannot reach the required temperature to perform the conversion from the insulating phase to the conductive phase, and since the protective layer (3) is in the insulating phase, it acts transparently against radar waves (G). Radar waves (G) passing through the protective layer (3) are absorbed on the radar absorbing layer (5) before they reach the body (2).

In an embodiment of the invention, the protective structure (1) comprises the magnetic layer (4) located on the protective layer (3) with a surface resistance value predetermined by the user that is higher than the surface resistance of the protective layer (3), thus obtaining a capacity increase in absorbing electromagnetic waves. The magnetic layer (4) has a surface resistance predetermined by the user, which is higher than the surface resistance of the protective layer (3) on which it is located. In this way, the absorbing capacity of the magnetic layer (4) is increased.

In an embodiment of the invention, the protective structure (1) comprises the magnetic layer (4) with a hexagonal ferrite structure, which heats up as a result of electromagnetic waves absorbed thereon and allows the protective layer (3) to be triggered directly such that the protective layer (3) is transformed into a conductive phase. Temperature of the magnetic layer (4) increases with the resonance frequency formed as a result of absorbing the warfare waves (F) on the magnetic layer (4). Therefore, temperature of the protective layer (3) also increases and phase transformation takes place. The phase transformation occurring on the protective layer (3) is triggered only and directly by the heating of the magnetic layer (4).

In an embodiment of the invention, the protective structure (1) comprises the protective layer (3) located on a surface of the body (2) that substantially surrounds the electronic equipment inside the air vehicle. Avionic equipment and/or computer equipment in the air vehicle may be affected by warfare waves (F). Warfare waves (F) can be prevented by the protective layer (3) located on the body (2), which substantially surrounds the areas containing the electronic equipment of the air vehicle.

In an embodiment of the invention, the protective structure (1) comprises the magnetic layer (4) located on the protective layer (3) with a thickness predetermined by the user in order to determine the magnetic impedance value. Impedance value of the magnetic layer (4) is determined by changing its thickness according to the impedance value of the warfare waves (F) to which it may be exposed.

In an embodiment of the invention, the protective structure (1) comprises the protective layer (3) which is doped with silicone, thus reducing the transition temperature from the monoclinic phase to the rutile phase. If the protective layer (3) made of vanadium dioxide is doped with silicone, transition temperature from the monoclinic phase to the rutile phase decreases, wherein the protective layer (3) is insulative in the monolithic phase, and conductive in the rutile phase. Therefore, the heat required for the phase transition of the protective layer (3) decreases, since its temperature is increased by being triggered as a result of the heating of the magnetic layer (4).

In an embodiment of the invention, the protective structure (1) comprises the radar absorbing layer (5) coated on the body (2) using the spraying method. The radar absorbing layer (5) can preferably be coated on the body (2) using the spray coating method.

In an embodiment of the invention, the protective structure (1) comprises the protective layer (3) which is coated on the radar absorbing layer (5) using the spraying method. The protective layer (3) can be coated on the radar absorbing layer (5), preferably using the spray coating method.

In an embodiment of the invention, the protective structure (1) comprises the magnetic layer (4) which is coated on the protective layer (3) using the spraying method. The magnetic layer (4) can be coated on the protective layer (3), preferably using the spray coating method.

In an embodiment of the invention, the protective structure (1) comprises at least one polymer layer (6) coated on the magnetic layer (4) using the spray coating method, which allows the magnetic layer (4) to be protected against factors such as humidity and/or friction. Thanks to the polymer layer (6), the magnetic layer (4) is prevented from being heated due to friction, and efficiency of the magnetic layer (4) can be prevented from decreasing due to other external factors such as humidity.

In one embodiment of the invention, the protective structure (1) comprises the magnetic layer (4) made of barium ferrite, manganese ferrite, cobalt ferrite, nickel ferrite, copper ferrite or zinc ferrite. Thanks to the magnetic layer made of magnetic materials contained in the hexaferrite group, the resonance frequency capacity is increased.

In an embodiment of the present invention, the protective structure (1) comprises the radar absorbing layer (5) made of indium tin oxide or zinc tin oxide. The radar absorbing layer (5) can preferably be doped with graphene, graphene oxide and/or carbon nanotube (CNT).

In an embodiment of the present invention, the protective structure (1) comprises the body (2) to which warfare waves (F) with an intensity or wavelength predetermined by the user are directed. The impedance value of the magnetic layer (4) can be determined according to the intensity or wavelength of the warfare waves (F) predetermined by the user.

In an embodiment of the invention, the protective structure (1) comprises the body (2) to which radar waves (G) with an intensity and wavelength predetermined by the user are directed. The impedance value of the magnetic layer (4) can be determined according to the intensity or wavelength of the radar waves (G) predetermined by the user.

1-15. (canceled)

16. A protective structure (1) comprising:
a body (2) which is an air and/or space vehicle;
at least one protective layer (3) made of vanadium oxide (VO2) located on the body (2) and has conductive or insulating properties at a temperature predetermined by the user;
at least one magnetic layer (4) coated on the protective layer (3) with an impedance value predetermined by the user, wherein when warfare waves (F) directed to the body (2) for an attack is almost equal to the impedance value predetermined by the user, the magnetic layer (4) substantially absorbs the warfare waves (F) and is heated by high resonance frequency, thus increasing a temperature of the protective layer (3) and rendering it a conductive structure, so that the warfare waves (F) are reflected back from the protective layer (3); and
at least one radar absorbing layer (5) located between the body (2) and the protective layer (3), wherein when radar waves (G) are directed at the air and/or space vehicle with an impedance value lower than the impedance of the magnetic layer (4) predetermined by the user, are at least partially absorbed on the magnetic layer (4) and create the low resonance frequency, the radar absorbing layer (5) allows the protective layer (3) to act as an insulator by remaining under the temperature predetermined by the user, and allows the radar waves (G) passing through the protective layer (3) to be substantially absorbed.

17. A protective structure (1) according to claim 16, wherein the magnetic layer (4) located on the protective layer (3) has a surface resistance value predetermined by the user that is higher than the surface resistance of the protective layer (3), thus obtaining a capacity increase in absorbing electromagnetic waves.

18. A protective structure (1) according to claim 16, wherein the magnetic layer (4) has a hexagonal ferrite structure, which heats up as a result of electromagnetic waves absorbed thereon and allows the protective layer (3) to be triggered directly such that the protective layer (3) is transformed into a conductive phase.

19. A protective structure (1) according claim 16, wherein the protective layer (3) located on a surface of the body (2) substantially surrounds the electronic equipment inside the air vehicle.

20. A protective structure (1) according claim 16, wherein the magnetic layer (4) located on the protective layer (3) has a thickness predetermined by the user in order to determine the magnetic impedance value.

21. A protective structure (1) according claim 16, wherein the protective layer (3) is doped with silicone, thus reducing the transition temperature from the monoclinic phase to the rutile phase.

22. A protective structure (1) according to claim 16, wherein the radar absorbing layer (5) is coated on the body (2) using a spraying method.

23. A protective structure (1) according to claim 16, wherein the protective layer (3) is coated on the radar absorbing layer (5) using a spraying method.

24. A protective structure (1) according claim 16, wherein the magnetic layer (4) is coated on the protective layer (3) using a spraying method.

25. A protective structure (1) according claim 16, comprising at least one polymer layer (6) coated on the magnetic layer (4) using a spray coating method which allows the magnetic layer (4) to be protected against factors such as humidity and/or friction.

26. A protective structure (1) according claim 16, wherein the magnetic layer (4) is made of barium ferrite, manganese ferrite, cobalt ferrite, nickel ferrite, copper ferrite or zinc ferrite.

27. A protective structure (1) according to claim 16, wherein the radar absorbing layer (5) is made of indium tin oxide or zinc tin oxide.

28. A protective structure (1) according claim 16, wherein the body (2) to which warfare waves (F) with an intensity or wavelength predetermined by the user are directed.

29. A protective structure (1) according claim 16, wherein the body (2) to which radar waves (G) with an intensity and wavelength predetermined by the user are directed.
